(19) United States
(12) Patent Application Publication
(10) Pub. No.: US 2013/0208992 A1
(43) Pub. Date: Aug. 15, 2013

(54) SYSTEM AND METHOD FOR DIFFERENCE FRAME THRESHOLD ENCODING AND DECODING

(71) Applicants: Shu Lin, San Diego, CA (US); Quang T. Trang, Carlsbad, CA (US)

(72) Inventors: Shu Lin, San Diego, CA (US); Quang T. Trang, Carlsbad, CA (US)

(21) Appl. No.: 13/766,003

(22) Filed: Feb. 13, 2013

Related U.S. Application Data
(60) Provisional application No. 61/598,268, filed on Feb. 13, 2012.

(51) Int. Cl. G06T 9/00

(52) U.S. Cl. CPC G06T 9/004
USPC 382/236

(57) ABSTRACT

A method for difference threshold encoding comprising designating a first frame of image data as a reference set. Designating a second frame of image data as a difference set. Comparing the reference set to the difference set to generate a difference metric. Encoding the second frame as a duplicate of the first frame if the difference metric is less than a threshold. Storing the second frame if the difference metric is equal to or greater than the threshold. Designating a third frame of image data as a second difference set. Comparing the second difference set to the reference set to generate a second difference metric. Designating the third frame of image data as a new reference set if the second difference metric is greater than a second threshold.

### RELATED APPLICATIONS

The present application claims benefit of U.S. Provisional patent application 61/598,268, entitled “SYSTEM AND METHOD FOR DIFFERENCE FRAME THRESHOLD ENCODING AND DECODING,” filed Feb. 13, 2012, which is hereby incorporated by reference for all purposes.

### TECHNICAL FIELD

The present disclosure pertains generally to image encoding, and more particularly to difference frame threshold encoding of image data.

### BACKGROUND OF THE INVENTION

There are many known techniques for encoding image data to reduce the size of the image data. Such image encoding techniques are generally incompatible with each other.

### SUMMARY OF THE INVENTION

A method for difference threshold encoding is disclosed that can be used in conjunction with existing image data encoding techniques to accomplish a greater amount of compression than would otherwise be possible. The method includes designating a first frame of image data as a reference set and designating a second frame of image data as a difference set. The reference set is compared to the difference set to generate a difference metric. The second frame is encoded as a duplicate of the first frame if the difference metric is less than a threshold. The second frame is stored if the difference metric is equal to or greater than the threshold. A third frame of image data is designated as a second difference set. The second difference set is compared to the reference set to generate a second difference metric, and the third frame of image data is designated as a new reference set if the second difference metric is greater than a second threshold.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of an exemplary image broken into minimum coded units, in accordance with an exemplary embodiment of the present disclosure;

FIGS. 2-4 are an exemplary illustration of a group of pictures of three frames;

FIG. 5 is a diagram of a system for DIFT encoding and decoding in accordance with an exemplary embodiment of the present disclosure;

FIG. 6 is diagram of an algorithm for DIFT encoding in accordance with an exemplary embodiment of the present disclosure;

FIG. 7 is a diagram of an algorithm 700 for DIFT encoding in accordance with an exemplary embodiment of the present disclosure;

FIG. 8 is a diagram of an algorithm for decoding a DIFT data stream in accordance with an exemplary embodiment of the present invention;

FIG. 9 is a diagram of an exemplary system for DIFT to JPEG decoder in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

The present disclosure pertains to a new encoding technique, referred to herein as difference frame threshold (DIFT) encoding. In one exemplary embodiment, a DIFT encoder generates a DIFT stream that can include one or more of six different modes that are used to compress the image data into minimum file sizes for storage or for transport over low power/low bit rate data mediums. The basic compression mode uses JPEG-compatible encoding techniques, although other suitable encoding techniques can also or alternately be used to reduce the compressed image file sizes before they are stored or transmitted and later reconstructed to full images for display.

As used herein, a minimum coded unit (MCU) is a minimum block of pixels used for encoding using the basic compression mode, such as JPEG. Generally, the number of pixels per block may depend on the chroma subsampling technique that is used. For example, when a 4:2:2 subsampling technique is being used, one MCU can be made up of 16×8 pixels. When a 4:2:0 subsampling technique is used, one MCU can be made up of 16×16 pixels. For a black and white subsampling technique, one MCU can be made up of 8×8 pixels. For a frame of VGA-encoded image data that is 640×480, there can be 40×60 MCUs for where a 4:2:2 subsampling technique is used, or 40×30 MCUs where a 4:2:0 subsampling technique is used. The total number of MCUs per image will therefore be a function of the image resolution, where higher resolution generally correlates to a greater number of MCUs.

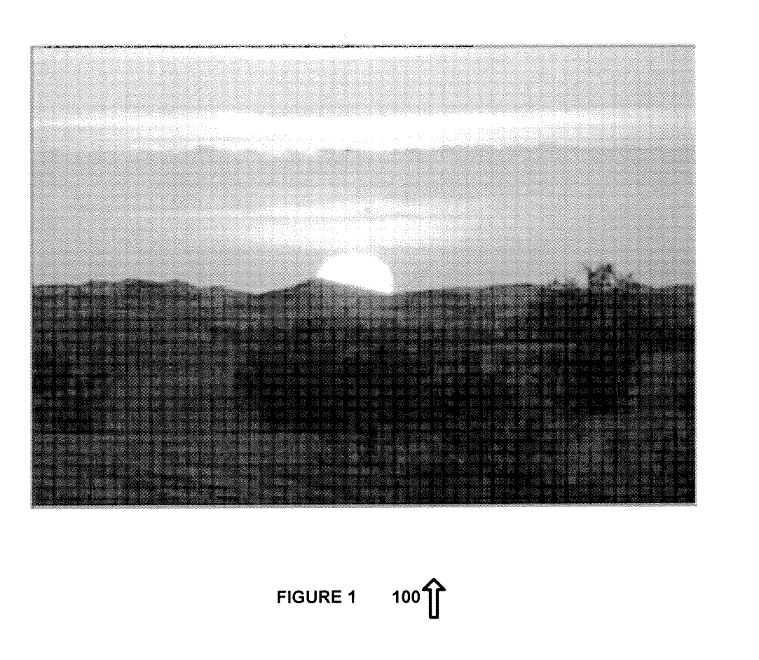

An MCU is essentially a small building block of the image data that is being processed. Each MCU can contain a small part of the image, much like a puzzle piece, such that when the MCUs are placed all together, the collection of MCUs forms the entire picture, as shown in FIG. 1. Although not to scale, the image has been broken down into small blocks to illustrate the individual MCUs.

While the basic compression is accomplished with standard JPEG or other suitable encoding techniques, additional compression is achieved by generating differencing frames. A “reference” frame is captured and is directly encoded into a suitable format, such as JPEG. The subsequent frames are encoded as relative difference frames in comparison to the “reference” frame (such as by using differential JPEG encoding), and are referred to as “difference” frames. Difference frames are also saved in the base encoding format, but when viewed in that format, contain only the parts of the scene that are different from the reference frame. In order to view the full scene, a difference frame is reconstructed by combining it with the reference frame in a suitable color format, such as RGB. Because difference frames contain only differences in the scene, they can be substantially smaller in byte count than the initial reference frame. The set of images (i.e., the reference and the N difference frames) is referred to as a Group of Pictures (GOP). A new reference frame is captured periodically to begin a new GOP.

For example, the selection of a reference frame can be based on a data compression level for a reference frame and a difference. In one exemplary embodiment, a first frame F1 can be designated as the reference frame and second frame F2 can be designated as a difference frame. If it is determined that there are no differences above a threshold between the two frames, then a third frame F3 can be designated as a second difference frame. Likewise, if it is determined that there are no differences between the third frame F3 and the reference frame F1 above the threshold, then a fourth frame F4 can also be designated as a difference frame. In this manner, the number of difference frames can be dynamically determined.

In another exemplary embodiment, a difference frame can be designated as a new reference frame, or can also or alternatively be used as a reference frame from a subsequent difference frame, using the same or a different threshold. In this exemplary embodiment, if no difference is determined between frames F1 and F2 above a first threshold, but a difference is determined between frames F1 and F3 and frames F1 and F4 that is above the first threshold, a subsequent analysis can be performed on frames F2, F3 and F4 to determine whether the difference between those frames exceeds the first threshold. If the difference between frames F2 and F3 and F2 and F4 does not exceed the first threshold, then frame F2 can be dynamically designated as a new reference frame, so as to avoid the need to encode difference frames for F3 and F4 relative to F1. In this manner, the disclosed DIFT encoding does not utilize a simple skipping algorithm, such as where every other frame is skipped, but rather designates reference frames and difference frames dynamically.

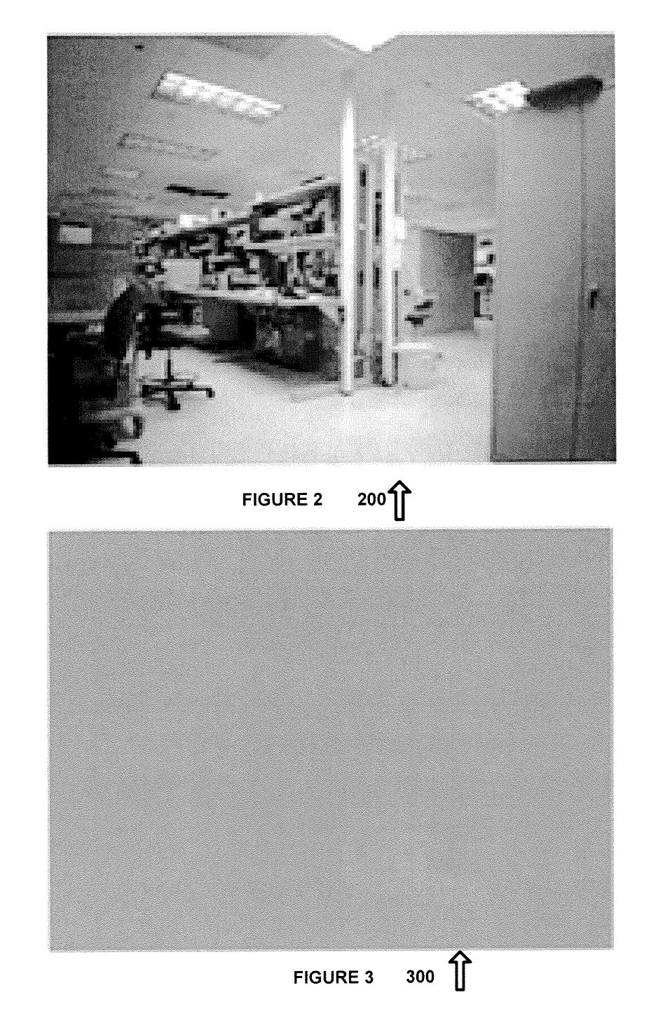

FIGS. 2-4 are an exemplary illustration of a GOP of three frames. FIG. 2 is an image of the reference frame, and has an associated JPEG file size of 29.5 KB.

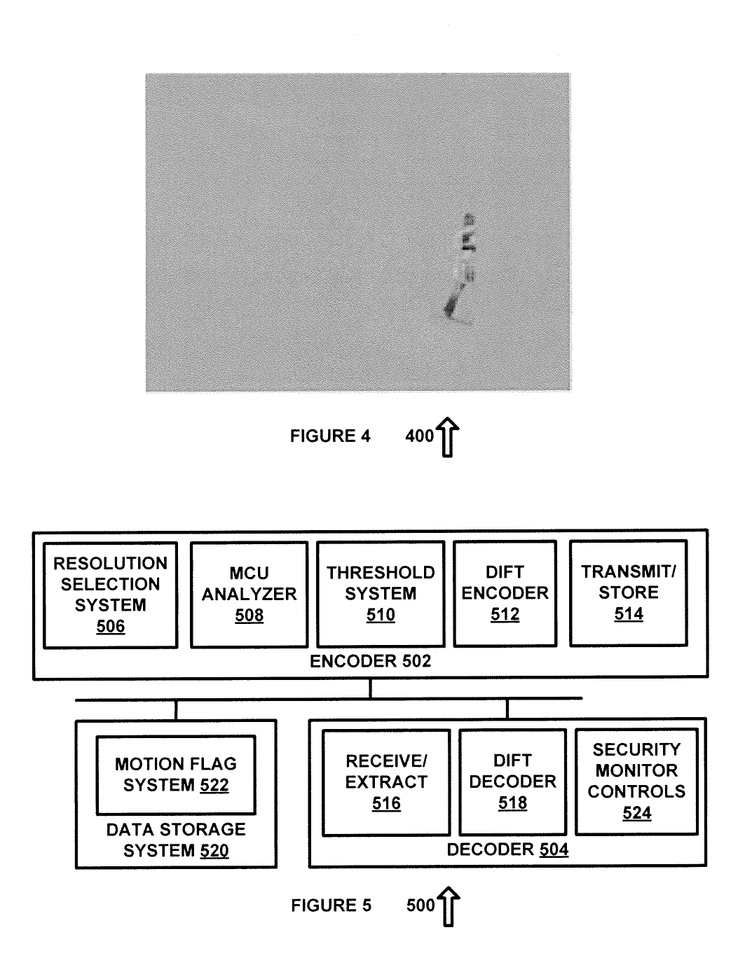

FIG. 3 is an image of the first difference frame with relatively no change in the scene, and with an associated JPEG file size of 8.0 KB. FIG. 4 is an image of the second difference frame showing with a person now walking into the scene, and with an associated JPEG file size of 8.8 KB. All areas of the image that did not change compared to the reference frame are grayed-out, resulting in much smaller compressed file sizes as shown under each picture (file sizes reflect VGA images).

Although the difference frame only encodes differences between the current frame and the reference frame, the difference frames are saved as full size images in the underlying encoding process. DIFT uses a threshold to determine whether or not each individual MCU has changed sufficiently and should be encoded. Only the MCUs that have changed with respect to the reference image are encoded in the underlying file compression technique encoded and saved. Encoding is performed at the MCU level and both DIFF and DIFT modes encode data using the underlying compression technique. DIFF mode encodes the differences between the current frame and the reference frame MCU, while DIFT encodes the current MCU data itself but only if it has changed enough to cross the threshold.

When utilizing the JPEG standard, DIFF mode provides a minimum of 32 bits of data per MCU for areas that are unchanged and grayed out but DIFT only uses one bit to identify an MCU that is not changed and therefore not encoded. As a result, for an image that is largely unchanged compared to the reference frame, the saved MCU data for a DIFT encoded image can be nearly 32 times smaller than a DIFF “Difference” image capture.

The reconstruction process of the DIFT MCU data essentially involves combining the MCUs of the reference frame that were unchanged with the MCUs of the difference frame (i.e., the MCUs that did change). In other words, the MCUs of the reference frame that were detected as changed get replaced with the new ones of the difference frame.

The threshold setting is a function of the intended application and can influence the quality and byte count of the image data saved. Given the exemplary FIGURES discussed above, a low threshold setting would allow subtle differences in exposure that can be seen between the reference frame and difference frame to be recognized and encoded. A higher threshold would process these differences as no change, resulting in the minimum file size possible by encoding only one bit per MCU. For a 4:2:0 VGA image, this would be: 40×30 MCUs 1 bit/MCU 1200 bits=150 bytes=minimum file size for unchanged scene.

The second difference frame has a small amount of change with a person walking into the scene. The threshold setting can be set such that the MCUs which occupy the space of the person in the scene are recognized and encoded while the relatively unchanged MCUs do not get encoded and can be represented by only one bit. Note that because encoding is based on a threshold setting, the areas around the moving object may become “blocky” in nature. In other words, the final reconstructed image may have some rough edging around the differences within the picture. A lower threshold will encode more subtle changes and result in better picture quality but increase file sizes as a result. A threshold of zero would result in all MCUs being encoded and therefore would produce a full encoded image with no further compression savings. For video surveillance, monitoring and motion detector applications, where the video data is stored for subsequent review, the use of a higher threshold might be acceptable. Likewise, a dynamic threshold can be utilized, such as to initially use a higher threshold and then to switch to a lower threshold once motion has been detected.

The received data may reflect an image that was encoded in JPEG, DIFF1, DIFT, DIFT-DIFF0, DIFT-DIFF0/DIFF or other suitable modes. The header preceding the file data will indicate which encoding mode was used in order for the decoding host to properly parse the data for reconstruction. Use of the combined DIFT and DIFF encoding techniques results in image files that can be made up of MCUs encoded in either DIFT (straight JPEG per MCU) or DIFF0/DIFF1 (JPEG of differences in pixels per MCU), MCUs that are simply left as is and not encoded, or other suitable processes. The reconstruction driver can read the 1 or 2 bit codes for each MCU in the current image file, determine which encoding method was used and then decode it accordingly. The individually decoded MCUs can then be assembled in a full RGB format for display or recombined as a full JPEG image.

FIG. 5 is a diagram of a system 500 for DIFT encoding and decoding in accordance with an exemplary embodiment of the present disclosure. System 500 can be used to perform DIFT encoding and decoding in accordance with the processes described above.

System 500 includes encoder 502, decoder 504, resolution selection system 506, MCU analyzer 508, threshold system 510, DIFT encoder 512, transmit/store 514, receive/extract 516, DIFT decoder 518 and data storage 520, which can be implemented in hardware or a suitable combination of hardware and software. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Resolution selection system 506 receives resolution data and identifies the corresponding MCU properties. In one exemplary embodiment, the number of MCUs per frame can be a function of the image resolution, such as where a 640×480 VGA image results in 40×60=2400 MCUs for a format of 4:2:2 or 40×30=1200 MCUs for a format of 4:2:0, where a higher resolution equals a greater number of MCUs. Resolution selection system 506 can configure an algorithm for processing of frames of image data, such as by setting one or more variables for processing of MCUs of each frame of image data in a data memory device, a data register, or in other suitable manners.

MCU analyzer 508 receives image data and analyzes minimum coded units of the image data for difference frame encoding. In one exemplary embodiment, MCU analyzer 508 can receive MCU property data from resolution selection system 506 and can process frames of image data based on the MCU property data, such as by designating reference frames and difference frames, by comparing MCUs of reference frames to corresponding MCUs of difference frames to generate a difference metric, applying a threshold to the difference metric for each set of compared MCUs, by storing a null set (such as the digital value zero or one or other suitable values) for difference frame MCUs that are below the threshold value, and in other suitable manners.

Threshold system 510 provides threshold data for MCU processing. In one exemplary embodiment, threshold system 510 can allow a user to interactively adjust a threshold based upon subjective image analysis, such as by selecting an increment control to increment the threshold upwards or downwards by a single threshold metric unit and to observe the effect on the encoded data. Threshold system 510 can also allow the threshold to be dynamically adjusted, such as for video surveillance, monitoring and motion detector applications, such as to have a high threshold for when long periods of time elapse during which no motion is expected, and to dynamically lower the threshold after motion has been detected. As previously discussed, a threshold setting that is too high can result in an image that is “blocky” to a viewer, and threshold system 510 can allow a user to adjust a threshold to obtain a desired level of compression for a given set of image data. Likewise, threshold system 510 can store preset thresholds for predetermined compression ratios (such as to compress data based on available bandwidth or file size), predetermined data source or destination types (such as for processing data for a predetermined video recorder or for display on a mobile device model), or for other suitable preset conditions.

DIFT encoder 512 receives MCU data for a reference frame and one or more difference frames and encodes a DIFT data frame, such as by storing a designation that an MCU in a difference frame should be identical to a corresponding MCU in the reference frame, identical to a corresponding MCU in a prior difference frame, a new MCU for that difference frame, or other suitable data. DIFT encoder 512 thus assembles a set of data that can be used by a DIFT decoder to reconstruct the original set of data in the original data format, such as JPEG, GIF, TIFF, PNG, BMP or other suitable data formats. DIFT encoder 512 can assemble a group of pictures that has two or more frames of data, such as a single reference frame and a single difference frame, a single reference frame and two difference frames, a single reference frame and three difference frames and so forth. Likewise, redesignation of a difference frame as a reference frame is possible, such as to achieve a higher compression ratio when subsequent frames can be compressed when compared to the current difference frame but would need to be separately encoded when compared to the current reference frame.

Transmit/store 514 transmits or stores the DIFT encoded data in a suitable manner, such as according to predetermined data format requirements for DIFT encoded data. In one exemplary embodiment, the data format requirements can specify the arrangement of header data that identifies a sequence number for sets of DIFT data, payload data that is used to reconstruct the image data, end of file data, error checking data, and other suitable data.

Receive/extract 516 can receive transmitted DIFT-encoded data or extract DIFT-encoded data from a data storage medium, such as a magnetic data storage medium, an optical data storage medium, a silicon data storage medium or other suitable data storage media. In one exemplary embodiment, the data can be received or extracted according to data format requirements that specify the arrangement of header data that identifies a sequence number for sets of DIFT data, payload data that is used to reconstruct the image data, end of file data, error checking data, and other suitable data.

DIFT decoder 518 constructs image data into an original data format, such as JPEG, GIF, TIFF, PNG, BMP or other suitable data formats from DIFT encoded data. In one exemplary embodiment, DIFT decoder 518 can extract a reference frame as a first frame in a group of pictures, can reconstruct subsequent frames of data in the group of pictures from difference frame data, and can perform other suitable processes to decode the DIFT-encoded data.

Data storage system 520 stores DIFT-encoded data and provides the stored data upon demand for decoding. Data storage system 520 can be a magnetic media data storage device or devices, an optical media data storage device or devices, a silicon data storage device or data storage device constructed from other integrated circuit memory devices, or other suitable data storage devices. Data storage system 520 can also include motion flag system 522, which can store motion detection flags for a video surveillance, monitoring and motion detector system.

Security monitor controls 524 can be implemented as one or more objects on a graphic user display such as a video display monitor or touch screen interface, each having associated graphic, functional and state data, as one or more digital controls, or in other suitable manners.

Security monitor controls 524 allows a user to review security monitor data that has been stored in data storage system 520 or other suitable locations. In one exemplary embodiment, security monitor controls 524 can include a motion flag system that generates one or more user-selectable graphic interface controls that allow the user to see one or more dates and associated times at which a motion flag was activated, such as when motion was detected by a DIFT encoder or in other suitable manners. When the user selects one of these motion flag controls, the video data associated with the motion flag can be extracted from memory and decoded, or other suitable processing can also or alternatively be performed. Security monitor controls 524 can further compile a group of adjacent or closely related frames that have associated motion flag data. For example, if a first sequence of 100 frames of image data have associated motion flag data, and a second sequence of 1000 frames of image data do not have associated motion flag data, the first sequence of 100 frames of image data can be grouped into a single first motion flag. Likewise, if a third sequence of 200 frames of image data follows the second sequence of 1000 frames of image and has associated motion flag data, that third sequence can be grouped into a single second motion flag. In this manner, motion flags can be dynamically grouped to facilitate review.

In operation, system 500 performs DIFT encoding and decoding, and allows an original data format, such as JPEG, GIF, TIFF, PNG, BMP, to be further compressed to achieve additional data transmission bandwidth or storage requirements reduction. While image data compression techniques such as JPEG, GIF, TIFF and PNG provide some reduction in data transmission bandwidth or storage requirements, they are not optimized for cases in which the majority of image data from frame to frame remains unchanged. DIFT encoding optimizes data compression for such situations.

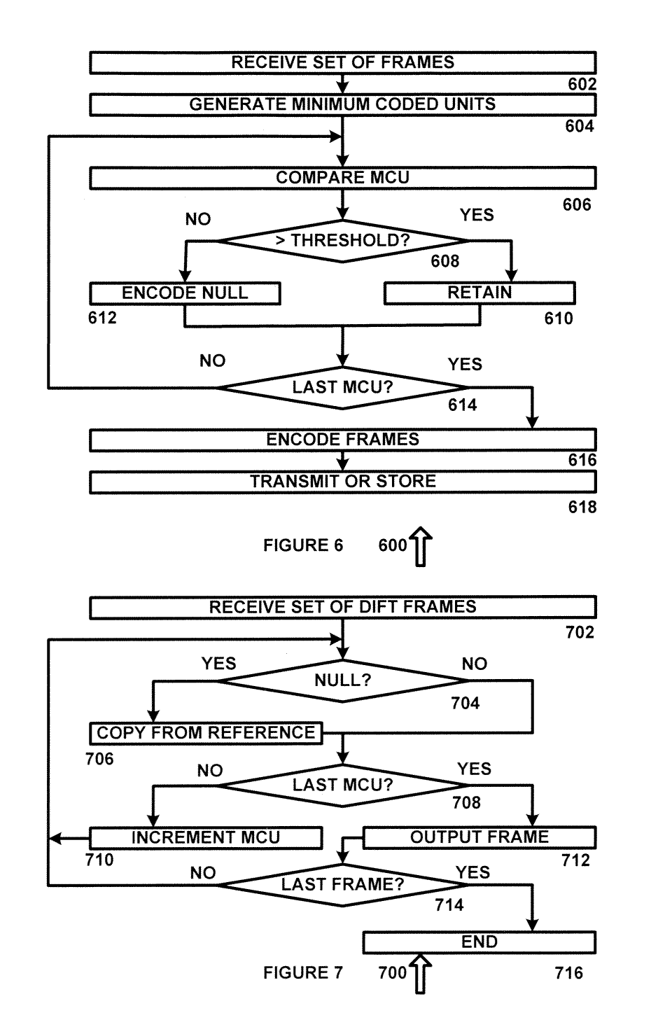

FIG. 6 is diagram of an algorithm 600 for DIFT encoding in accordance with an exemplary embodiment of the present disclosure. Algorithm 600 can be implemented as one or more hardware systems or as one or more software systems operating on a suitable processing platform.

Algorithm 600 begins at 602, where a set frames of image data is received. In one exemplary embodiment, the set of frames of image data can be in JPEG, GIF, TIFF, PNG, BMP or other suitable compressed or uncompressed image data formats. The frames are designated as a reference frame and a set of one or more difference frames. The algorithm then proceeds to 604.

At 604, minimum coded units are generated for the image data, such as based on chroma subsampling, video compression formats, or other suitable data. The minimum coded units can identify a sequence of subsets of image data for each frame, or other suitable data. The algorithm then proceeds to 606.

At 606, a first MCU for a reference frame and a difference frame are identified and compared, such as by performing a pixel-by-pixel comparison and generating a comparison metric, such as one or more chroma difference values, luminance difference values or other suitable data. Likewise, a first MCU for a first difference frame can be compared to a first MCU for a second difference frame, such as where the first difference frame includes motion data. The algorithm then proceeds to 608, where it is determined whether the comparison metric exceeds a threshold value. In one exemplary embodiment, the threshold value can be one or more values that correlate to the comparison being performed, such as a threshold for chrominance values, a threshold for luminance values, or other suitable values. If it is determined that the comparison metric does not exceed the threshold, the algorithm proceeds to 612, where a null value for the comparison is stored for the corresponding MCU, to indicate that the image data from the reference frame or previous difference frame should be used for that MCU. Otherwise, the algorithm proceeds to 610, where the image data for that MCU for the difference frame is retained. In addition, a motion detection indication can be generated, such as to indicate that motion has been detected for a video surveillance, monitoring and motion detector system. The algorithm proceeds from 610 or 612 to 614.

At 614, it is determined whether the last MCU for the difference frame has been processed. If the last MCU for the difference frame has not been processed, the MCU is incremented to the next MCU, and the algorithm returns to 606, where the process is repeated using the next MCU in place of the first MCU. If the last MCU for the difference frame has been processed, the algorithm proceeds to 616.

At 616, the reference frame and difference frame are encoded as DIFT data. In one exemplary embodiment, a null value can be encoded for each MCU of a difference frame that is identical to the MCU of the reference frame, run length encoding can be used to identify sets of MCUs for a difference that are identical to corresponding MCUs of the reference frame, or other suitable processes can also or alternatively be used. Likewise, where more than one difference frame is being used, the encoding process can be repeated for each difference frame and the additional difference frames can also be encoded. The algorithm then proceeds to 618 where the DIFT encoded data is transmitted or stored.

In operation, algorithm 600 allows data in a native data format to be further compressed using DIFT encoding. Algorithm 600 thus provides additional lossy data reduction/compression in conjunction with existing data reduction/compression processes.

FIG. 7 is a diagram of an algorithm 700 for DIFT encoding in accordance with an exemplary embodiment of the present disclosure. Algorithm 700 can be implemented as one or more hardware systems or as one or more software systems operating on a suitable processing platform.

Algorithm 700 begins at 702, where a set of DIFT encoded data frames are received. An MCU counter can also be set, such as to identify the current MCU for processing, where the MCUs can be analyzed in any suitable order, such as starting with a first MCU, a first MCU for a difference frame that is identified as not being a duplicate of the reference frame MCU, or in other suitable manners. The algorithm then proceeds to 704.

At 704, it is determined whether a null set for an MCU or group of MCUs has been stored. If it is determined that a null set has not been stored, the algorithm proceeds to 708. If it is determined that the null set has been stored, the algorithm proceeds to 706 where an MCU or set of MCUs from a reference frame are copied for the corresponding MCUs of the difference frame. Likewise, where MCUs for a previous difference frame are indicated, the relevant MCUs are copied. The algorithm then proceeds to 708.

At 708, it is determined whether the last MCU for a difference frame has been decoded. If the last MCU has not been decoded, the algorithm proceeds to 710, where the MCU counter is incremented, and then returns to 704. If it is determined that the last MCU has been decoded, the algorithm proceeds to 712 where the decoded frame is output, such as to a buffer or other suitable location. The algorithm then proceeds to 714.

At 714, it is determined whether a last frame of the group of pictures has been processed. If the last frame has not been processed, the algorithm returns to 704, otherwise, the algorithm proceeds to 716 and terminates.

In operation, algorithm 700 allows DIFT-encoded data to be decoded to generate image data in a suitable data format, such as JPEG, GIF, TIFF, PNG, BMP or other suitable compressed or uncompressed image data formats. The DIFT decoding process allows data that has been compressed beyond the data compression capabilities of such compression formats to be received and decoded.

To decode a DIFT frame into a JPEG frame and reconstruct a final frame of image data after it is decoded by a JPEG decoder, additional decoding steps are required because a JPEG decoder cannot decode a DIFT frame. In one exemplary embodiment, six compression modes can be used: standard JPEG; DIFF1; DIFT; DIFT with threshold; DIFT-DIFF0; and DIFT-DIFF1. In this exemplary embodiment, there can be four types of compression MCUs: a JPEG MCU; a DIFF0 MCU; a DIFF1 MCU; and a SKIP MCU.

The standard set of JPEG image data can include JPEG MCUs only. A set of DIFF1 image data can include DIFF1 MCUs only. A set of DIFT image data can include JPEG MCUs and Skip MCUs. A set of DIFT-DIFF0 image data can include JPEG, DIFF0, and Skip MCUs. A set of DIFT-DIFF1 image data can include JPEG, DIFF0, DIFF1, and Skip MCUs.

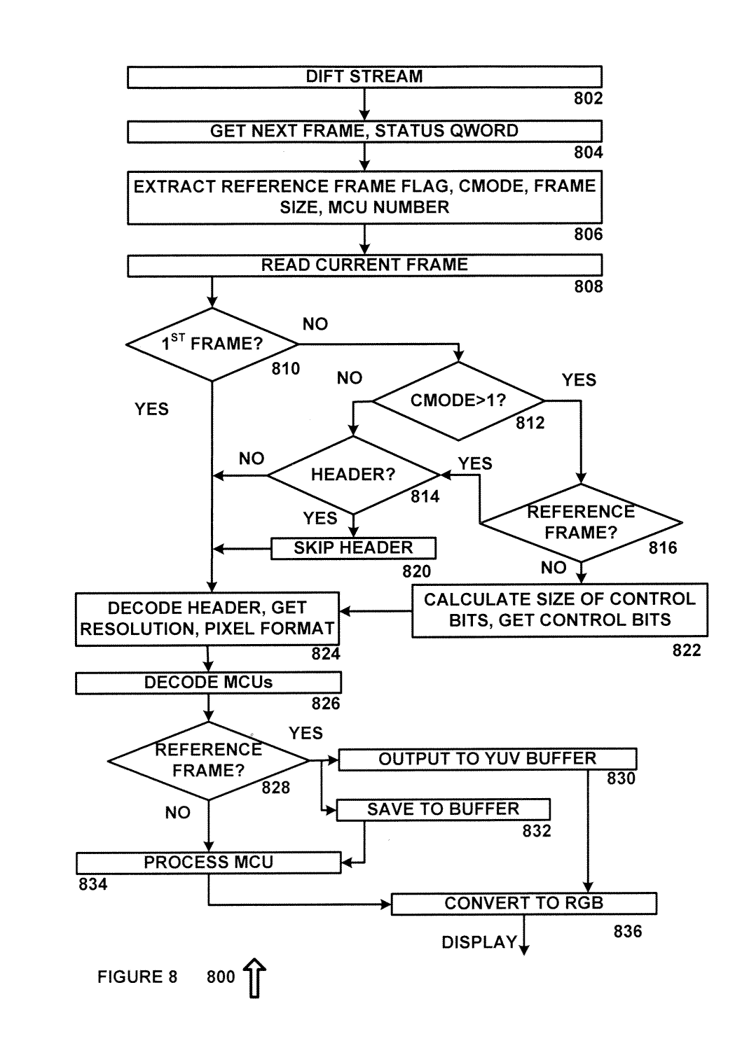

FIG. 8 is a diagram of an algorithm 800 for decoding a DIFT data stream in accordance with an exemplary embodiment of the present invention. Algorithm 800 can be implemented as code operating on a processor, as one or more discrete devices, as an application-specific integrated circuit or in other suitable manners.

Algorithm 800 begins at 802, where the DIFT data stream is received and proceeds to 804, where a next frame and a status qword is extracted from the DIFT data stream. The algorithm then proceeds to 806, where the reference frame flag, cmode value, frame size and number of MCUs is extracted, as the number of encoded MCUs will vary from frame to frame in DIFT encoding. In order to decode, all the encoded MCUs are collected to form a frame. If the encoded MCUs cannot fill the frame, dummy MCUs are padded to fill it. The algorithm then proceeds to 810.

At 810, it is determined whether the current frame is a first frame. If not, the algorithm proceeds to 812, where it is determined whether the value of cmode is greater than one. a header for the original compression technique (JPEG in this example) is then created and used to form a valid JPEG frame that can be decoded by a suitable JPEG decoder. The decoded data can be used to reconstruct the final image along with the control bits and the reference frame. In one exemplary embodiment, the general process consists of following steps. In step 1, a status qword is extracted from the DIFT frame, along with the number of encoded MCUs (cmode), and the stuffing bits of the last byte of last encoded MCU. In step 2, the motion detection bits (if any) and control bits (if any) are extracted. In step 3, dummy MCUs are padded to fill the image data frame, and the new frame width and height are calculated. In step 4, a JPEG header is created with pixel format and quantizer tables, and the header is inserted to form a JPEG picture. As discussed in greater detail below, additional steps can be used.

As shown in FIG. 8, it can be determined whether the frame that is being received is a first frame. If so, then the JPEG header (in this example—other suitable data formats can alternatively be used) is decoded to obtain the resolution and pixel format. The MCUs of the JPEG frame are then decoded. If it is determined that the frame is not a reference frame (which would normally be the case for a first frame), for each MCU: [1] if the MCU is JPEG encoded, it is copied to a YUV buffer; [2] if the MCU is DIFF0, then a reference is added and output to the YUV buffer; [3] if the MCU is DIFF1, the data is shifted, the reference is added and the result is output to the YUV buffer; or [4] if the MCU is skipped, the reference MCU is copied and output to the YUV buffer. The next frame is then retrieved.

If the received frame is not a first frame, it is determined whether CMODE is greater than 1. If so, then the algorithm proceeds to 816 where it is determined whether a reference frame has been received. If not, then the algorithm proceeds to 822 where the size of the control bits is calculated and the control bits are obtained. The algorithm then proceeds to 824.

If it is determined at 812 that the value of cmode is not greater than one, then the algorithm proceeds to 814 where it is determined whether a header is available, such as a JPEG header. If so, then the header is skipped at 820 and the algorithm proceeds to 824 where the frame MCUs are decoded. If it is determined at 814 that a header is not available, the algorithm proceeds to 824.

At 824, the MCU decoding process is initiated by decoding the header, getting the image resolution and pixel format, and the MCUs are then decoded at 826. The algorithm then proceeds to 828, where it is determined whether a reference frame has been received after the MCUs are decoded. If so, then the algorithm proceeds to 832 where the reference frame is saved to a local buffer, and also to 830 where the reference frame is output to a YUV buffer. The data is then converted from YUV to RGB at 836 and displayed, using the appropriate processing in [1] through [4]. If it is determined that a reference frame has not been received at 824, the algorithm proceeds to 834 where the MCUs are processed and then to 836 where they are converted to RGB and displayed.

In operation, algorithm 800 allows a stream of DIFT data to be processed and converted to video, such as where the DIFT data has been stored by a video surveillance, monitoring and motion detector system. Algorithm 800 thus allows highly compressed video data to be reconstructed for viewing.

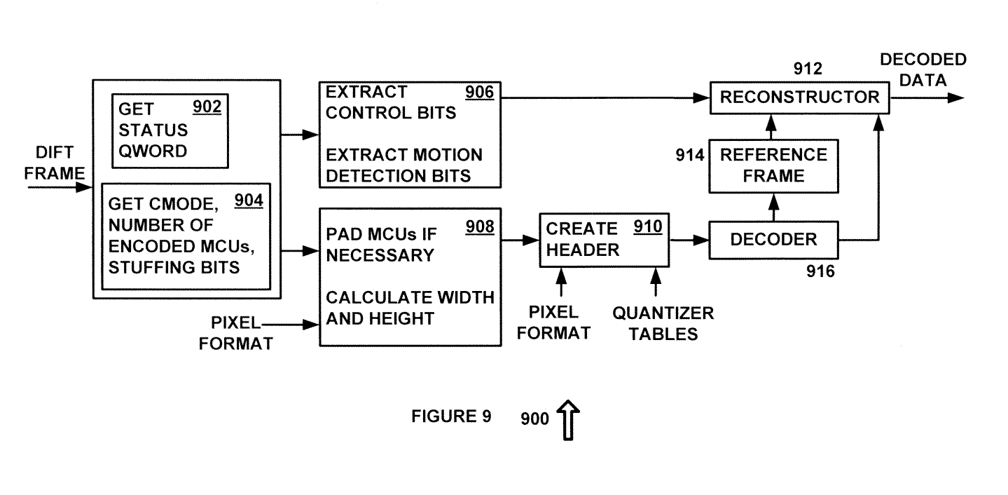

FIG. 9 is a diagram of an exemplary system for DIFT to JPEG decoder in accordance with an exemplary embodiment of the present disclosure.

The DIFT decoder includes a first processing block 902 tar receiving a DIFT frame and getting the status qword from the DIFT frame, and a second processing block 904 for receiving the DIFT frame and extracting the CMODE value, the number of encoded MCUs and the stuffing bits of the last byte of last encoded MCU.

A third processing block 906 receives the output of the first processing block 906 and extracts control bits and motion detection bits, if any. A fourth processing block 908 receives the output of the second processing block 904 and pixel format data, pads dummy MCUs to form a frame and calculates the frame width and height.

A fifth processing block 910 receives the output of the fourth processing block 908 and creates a JPEG header in conjunction with pixel format data and quantizer tables. The header is inserted to form a JPEG picture.

The JPEG picture is then output from the fifth processing block 910 to a JPEG decoder 916 and is stored in a reference frame buffer 914 if it is a reference frame. Otherwise, the JPEG picture is sent to reconstructor 912 to reconstruct the final picture with the control bits and the cmode, and then output to display.

In one exemplary embodiment, the number of control bits for each MCU is:

| Cmode | number of control bits |
|---|---|
| Std/Normal JPEG | No ctrl bits |
| DIFF1 | No ctrl bits |
| DIFT | 1 ctrl bit |
| DIFT-DIFF0 | 1 ctrl bit |
| DIFT/DIFF0 | 2 ctrl bits |
| DIFT-DIFF0/1 | 2 ctrl bits |

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for difference threshold encoding comprising:
designating a first frame of image data as a reference set;
designating a second frame of image data as a first difference set;
comparing the reference set to the first difference set to generate a first difference metric;
encoding the second frame as a duplicate of the first frame if the first difference metric is less than a first threshold; and
storing a first difference frame if the first difference metric is equal to or greater than the first threshold.

2. The method of claim 1 wherein adding the first difference frame to the reference set yields the first difference set.

3. The method of claim 1 further comprising designating a third frame of image data as a second difference set.

4. The method of claim 3 further comprising comparing the second difference set to the reference set to generate a second difference metric.

5. The method of claim 4 further comprising designating the third frame of image data as a new reference set if the second difference metric is greater than the first threshold.

6. The method of claim 4 further comprising encoding the third frame of image data as a duplicate of the first frame if the first difference metric is less than the first threshold.

7. The method of claim 4 further comprising storing a second difference frame if the second difference metric is equal to or greater than the first threshold

8. The method of claim 7 wherein adding the second difference frame to the reference set yields the second difference set.

9. A system for encoding data comprising:
a resolution selection system configured to generate a user control for selection of a resolution and to generate resolution selection data;
a threshold system configured to receive the resolution selection data and to generate threshold data; and
a DIFT encoder configured to receive a series of frames of image data, to generate a difference metric based on a difference between a reference frame of the series of frames of image data and a difference frame of the series of frames of image data and to store a difference set of image data if the difference metric is greater than the threshold data.

10. The system of claim 9 further comprising an MCU analyzer configured to generate a plurality of minimum coded units for each of the frames of image data.

11. The system of claim 10 wherein the DIFT encoder is configured to generate a difference metric based on a difference between an MCU of the reference frame of the series of frames of image data and a corresponding MCU of the difference frame of the series of frames of image data and to store a difference set of image data for the corresponding MCU of the difference frame if the difference metric is greater than the threshold data.

12. The system of claim 9 further comprising a motion flag system configured to store motion flag data for the difference frame if the if the difference metric is greater than the threshold data.

13. The system of claim 12 further comprising a DIFT decoder configured to generate the difference frame of the series of frames of image data by adding the difference set of image data to the reference frame of image data.

14. The system of claim 9 further comprising a security monitor control configured to generate one or more user-selectable controls to allow a user to identify sets of difference frame data having associated motion flag data.

15. A method for difference threshold decoding comprising:
receiving encoded data;
extracting a number of encoded minimum coded units (MCUs) from the encoded data;
extracting a first reference frame from the encoded data;
reconstructing one or more subsequent first difference frames by adding the encoded data to the first frame; and
converting the first reference frame and the subsequent first difference frames into a display format.

16. The method of claim 15 further comprising:
extracting control data from the encoded data;
identifying a location of a second reference frame within the encoded data;
extracting the second reference frame from the encoded data; and
reconstructing one or more subsequent second difference frames by adding the encoded data to the second reference frame.

17. The method of claim 15 wherein receiving encoded data comprises:
receiving a user selection of one or more motion detection flags; and
extracting encoded data from a data memory corresponding to one or more frames of data associated with the motion detection flags.

18. The method of claim 15 further comprising padding a frame of data with one or more dummy MCUs.

19. The method of claim 15 further comprising:
subtracting the number of encoded MCUs from a number of MCUs required to complete a frame of data to generate a missing number of MCUs; and
generating dummy MCUs for each of the missing number of MCUs.
